(19) United States
(12) Patent Application Publication
(10) Pub. No.: US 2022/0304340 A1
(43) Pub. Date: Sep. 29, 2022

(54) A PREPARATION METHOD OF COMPOSITE JUICE MIXED BY NONI FRUIT AND BLUEBERRY

(71) Applicant: HAINAN NORMAL UNIVERSITY, Haikou City, Hainan (CN)

(72) Inventors: Xiaobao Li, Haikou City, Hainan (CN); Guangying Chen, Haikou City, Hainan (CN); Zhangxin Yu, Haikou City, Hainan (CN); Danyu Huang, Liyang, Jiangsu (CN); Ting Zhao, Haikou City, Hainan (CN); Longyu Sun, Haikou City, Hainan (CN); Tao Zhang, Haikou City, Hainan (CN)

(21) Appl. No.: 17/593,647

(22) PCT Filed: Mar. 31, 2021
(86) PCT No.: PCT/CN2021/084638

§ 371 Date: Sep. 22, 2021

(30) Foreign Application Priority Data
Jun. 28, 2020 (CN) 202010598350.8

(51) Int. Cl. A23L 2/38; A23L 2/84; A23L 2/04; A23L 5/30

(52) U.S. Cl. CPC A23L 2/382; A23L 2/84; A23L 2/04; A23L 5/30

(57) ABSTRACT

Provided is a preparation method of composite juice mixed by noni fruit and blueberry, which includes the following steps: a noni fruit pre-fermentation, a blueberry pretreatment, a composite fruit juice fermentation, a filtration and a centrifugation. The prepared composite juice mixed by noni fruit and blueberry has a clear and transparent form, no precipitation, uniformity, no suspended matter, rich blueberry aroma, not pungent, soft taste, moderate sweet and sour, purple luster and translucent.

### FIELD OF THE INVENTION

The invention relates to the field of food processing, in particular to a preparation method of composite juice mixed by noni fruit and blueberry.

### BACKGROUND OF THE INVENTION

Noni is the fruit of Morinda citrifolia. Noni is a shrub to a small tree, 1 to 5 meters high, with straight stems and nearly quadrangular prism-shaped branches. The leaves are alternately opposite, oblong, elliptical or ovoid, 12˜25 cm long, acuminate or sharp at both ends, usually shiny, glabrous, and entire. Ripe noni fruit has a strong smell, and tastes poor after eating fresh or squeezing juice.

The anthocyanin content of blueberries is the highest among all fruits and vegetables, and the most abundant part of anthocyanins of blueberries is the part of the purple peel. The anthocyanins contained in blueberries have a superior physiological activity than general plant anthocyanins.

The current noni fruit-related products include enzymes, composite juices, etc. However, in the existing process, traditional fermentation processes improve the taste, resulting in the loss of anthocyanins after the composite fermentation of noni fruit and blueberries, and the addition of skin dregs makes the juice to be poor stability and pigmentation, easy to layer and other phenomena.

### BRIEF SUMMARY OF THE INVENTION

In view of this, provided is a preparation method of composite juice mixed by noni fruit and blueberry to solve the problem of the loss of anthocyanins caused by the composite fermentation of noni fruit and blueberry after the traditional fermentation process improves the taste, and to solve the problem that the juice has poor stability and pigmentation, easy to stratification and other phenomena after adding the skin dregs.

The technical solution of the present invention is realized as follows: a preparation method of composite juice mixed by noni fruit and blueberry includes the following steps:

The step S1 of noni fruit pre-fermentation: brushing the skin of mature noni fruit; cutting it into slices with a thickness of 1˜5 mm; according to the weight ratio, white sugar:noni fruit:water=(0.8˜1.2):(1˜3):(10˜30), putting them into the fermentation container; then adding yeast and leaving it in a cool place to ferment for 3˜6 months; shaking the fermentation container every day for the first month; after the fermentation, filtering the material, and using the filtrate thereof to obtain a noni enzyme;

The step S2 of blueberry pretreatment: washing and drying blueberries, then sending them to the freezer at −15˜24° C. to freeze for 4˜8 h, taking them out and crushing them to obtain a mixture of blueberry juice and skin dregs, which will be warmed up naturally for later use;

The step S3 of fermentation of composite juice: adding the noni enzyme of the step S1 and the mixture of blueberry juice and skin dregs of the step S2 into the fermentation container, raising temperature of the material to 20˜30° C., adding yeast and pectinase, stirring evenly, and fermenting for 20˜24 h;

The step S4 of filtration and centrifugation: filtering the fermented material with a mesh screen to remove the blueberry skin dregs, centrifuging the obtained filtrate, taking the supernatant after centrifugation, filtering through a membrane filter or diatomaceous earth filter, degassing and filling, accordingly obtaining the composite juice.

Alternatively, in the step S1 of noni fruit pre-fermentation, the ambient temperature in the cool place is 10˜18° C.

Alternatively, in the step S1 of noni fruit pre-fermentation, the yeast is Kluyveromyces marxianus, and the yeast with 100˜110 fu/g inoculum amount being inoculated.

Alternatively, in the step S1 of noni fruit pre-fermentation, the fermentation container is shaken for 2 to 4 hours every day for the first month, and the shaking frequency is 300˜500 rpm.

Alternatively, in the step S2 of blueberry pretreatment, the temperature is naturally raised to 15˜20° C.

Alternatively, in the step S3 of fermentation of composite juice, the mass ratio of the noni enzyme to the mixture of blueberry juice and skin dregs is 1:0.5˜2.

Alternatively, in the step S3 of fermentation of composite juice, 8˜10 parts by weight of yeast and 0.5˜1.5 parts by weight of pectinase are added to the fermentation container.

Alternatively, in the step S3 of fermentation of composite juice, a fermentation temperature is 20˜33° C.

Alternatively, in the step S4 of filtration and centrifugation, a centrifugal speed is 3000˜5000 rpm, and the centrifugal time is 30˜50 min.

Alternatively, in the step S4 of filtration and centrifugation, the filtration temperature is 40˜60° C., and the pressure is 0.5˜3 MPa.

Compared with the prior art, the beneficial effects of the present invention are:

(1) The present invention uses the whole fruit instead of just the juice for fermentation, and the nutrients in the pulp and peel are entered into the juice by mean of fermentation and lixiviating, making the juice richer and higher in content. The fermentation of blueberries and noni fruit together significantly improves the flavor and taste of the noni fruit. In the composite juice obtained after fermentation, the odor of the noni fruit itself is eliminated and the taste is improved.

(2) In the present invention, the blueberries are pretreated with quickly freezing before they are broken. After the blueberries are quickly frozen, a large number of ice crystals will be produced in the blueberries. The ice crystals destroy the plant tissue structure, make it easier for anthocyanins to enter the juice and increase the anthocyanin content of the juice; The taste of frozen blueberries after fermentation is more refreshing than fresh blueberries.

(3) The present invention uses a variety of methods to increase and retain the anthocyanin content in the composite juice. 1) Select two kinds of fruits with high anthocyanin content, noni and blueberry; 2) Ferment the noni to make the anthocyanin enter into the enzyme; 3) The blueberry is quickly frozen to destroy the skin and pulp structure, so that the anthocyanin is able to enter into the juice as much as possible; 4) The broken raw fruit, namely the mixture of blueberry juice and skin dregs, is used during fermentation. The natural yeast of the skin dregs of blueberry is used for fermentation, and the tannins and pigments of the skin dregs are incorporated into the juice during the fermentation. The natural yeast and the yeast of the present invention ferment together to produce more unique flavors; 5) temperature control throughout the process is below 35° C., to avoid the damage of anthocyanins caused by high temperatures.

(4) In order to improve the clarity of the juice, in the present invention pectinase is added during fermentation, and it is used the centrifugal means with membrane filtration means to obtain a clear and transparent juice.

### DETAILED DESCRIPTION OF THE INVENTION

In order to help better understand the technical content of the present invention, specific embodiments are provided below to further illustrate the present invention.

Unless otherwise specified, the experimental methods used in the embodiments of the present invention are conventional methods.

The materials, reagents, etc. used in the embodiments of the present invention can be obtained from commercial sources unless otherwise specified.

### Embodiment 1

The preparation method of composite juice mixed by noni fruit and blueberry of this embodiment includes the following steps:

Step S1, Noni Fruit Pre-Fermentation

Firstly, washing the skin of the mature noni fruits with a brush and drying them, and cutting them into slices with a thickness of 1 to 5 mm.

Then according to the weight ratio of white sugar:noni fruit:water=1:2:20, putting them into a clean fermentation container, and adding yeast into it, the yeast (Kluyveromyces marxianus) with 105 fu/g inoculum amount being inoculated, leaving 20˜30% of the space in the fermentation container for fermentation.

Finally, the fermentation container being placed in a cool place at 10° C. for 4 months of fermentation; in the first month, the fermentation container being shaken every day for 3 hours at a frequency of 400 rpm; after the end, the material in the fermentation container being filtered, and the filtrate being ready for use; the filtrate was called noni fruit enzymes.

Step S2, Blueberry Pretreatment

Washing the picked blueberries (0.15 g anthocyanin content per 100 g of fresh fruit), drying them, and then sending them to the freezer at −18° C. to freeze for 6 hours; taking the blueberries out of the freezer and directly sending them to the crusher for crushing, to obtain the mixture of blueberry juice and skin dregs, then being naturally heated to 18° C. for later use.

Step S3, Composite Juice Fermentation

Adding 100 g of the noni enzyme prepared in the step S1 and 100 g of the mixture of blueberry juice and skin dregs obtained in the step S2 into the fermenter, raising the temperature of the material to 20° C., adding 10 g Kluyveromyces marxianus and 1 g pectinase, and stirring them well, afterwards, keeping the fermentation at 25° C. for 24 hours;

Step S4, Filter Centrifugation

The material obtained after fermentation in the step S3 being first filtered with a mesh screen to remove the skin dregs of blueberry, and the obtained filtrate being centrifuged at a centrifugal speed of 4000 rpm and a centrifugal time of 40 min; after centrifugation, the supernatant being taken and passed through a membrane filter at a filtration temperature of 50° C. and a pressure of 1.7 MPa, to obtain a clear mixed juice, then degassed and filled.

If the juice should be diluted, and be added with sugar or other corrigent to season, it is the supernatant after centrifugation to be added with the said sugar and the said other materials, and then filtering it through a filter.

In this step, the juice is clarified by the membrane filter, which not only has the clarification effect, but also removes the bacteria, which has the effect of sterilizing and ensuring the termination of fermentation.

### Embodiment 2

The preparation method of composite juice mixed by noni fruit and blueberry of this embodiment includes the following steps:

Step S1, Noni Fruit Pre-Fermentation

Firstly, washing the skin of the mature noni fruit with a brush and drying them, and cutting them into slices with a thickness of 1 to 5 mm.

Then according to the weight ratio of white sugar:noni fruit:water=0.8:1:10 putting them into a clean fermentation container, and adding Kluyveromyces marxianus into it, the yeast (Kluyveromyces marxianus) with an inoculum amount of 100 cfu/g being inoculated, and leaving 20˜30% of the space in the fermentation container for fermentation.

Finally, the fermentation container being placed in a cool place at 18° C. for 3 months of fermentation; in the first month, the fermentation container being shaken every day for 2 hours with a shaking frequency of 300 rpm; after the completion of the fermentation, the materials in the fermentation container being filtered, and the filtrate being ready for use; the filtrate being called noni fruit enzymes.

Step S2, Blueberry Pretreatment

Washing the picked blueberries (0.15 g anthocyanin content per 100 g of fresh fruit), drying them, and then sending them to the freezer at −15° C. to freeze for 4 hours; taking the blueberries out of the freezer and directly sending them to the crusher for crushing, to obtain the mixture of blueberry juice and skin dregs, then being naturally heated to 15° C. for later use.

Step S3, Composite Juice Fermentation

Adding 100 g of the noni enzyme prepared in step S1 and 50 g of the mixture of blueberry juice and skin dregs obtained in step S2 into the fermenter, raising the temperature of the material to 25° C., and adding 8g of Kluyveromyces marxianus and 0.5 g pectinase, and stirring them well, afterwards, keeping the fermentation at 20° C. for 20 hours.

Step S4, Filter Centrifugation

The material obtained after fermentation being filtered with a mesh screen to remove the skin dregs of blueberry, and the obtained filtrate being centrifuged at a centrifugal speed of 3000 rpm and a centrifugal time of 30 min; after centrifugation, the supernatant being taken and filtered through a diatomaceous earth filter at a filtration temperature of 40° C. and a pressure of 0.5 MPa, to obtain a clear mixed juice, then degassed and filled.

If the juice should be diluted, and be added with sugar or other corrigent to season, it is the supernatant after centrifugation to be added with the said sugar and the said other materials, and then filtering it through a filter.

In this step, the juice is clarified by the membrane filter, which not only has the clarification effect, but also removes the bacteria, which has the effect of sterilizing and ensuring the termination of fermentation.

### Embodiment 3

The preparation method of composite juice mixed by noni fruit and blueberry of this embodiment includes the following steps:

S1, Noni Fruit Pre-Fermentation

Firstly, washing the skin of the mature noni fruits with a brush and drying them, and cutting them into slices with a thickness of 1 to 5 mm.

Then according to the weight ratio of white sugar:noni fruit:water=1.2:3:30, putting them into a clean fermentation container, adding Kluyveromyces marxianus into it, the yeast (Kluyveromyces marxianus) with an inoculum amount of 110 cfu/g being inoculated, and leaving 20˜30% of the space in the fermentation container for fermentation.

Finally, the fermentation container being placed in a cool place at 15° C. for 6 months of fermentation; in the first month, the fermentation container being shaken every day for 4 hours at a shaking frequency of 500 rpm; after the completion of the fermentation, the material in the fermentation container being filtered, and the filtrate being ready for use; the filtrate being called noni fruit enzymes.

Step S2, Blueberry Pretreatment

Washing the picked blueberries (0.15 g anthocyanin content per 100 g of fresh fruit), drying them, and then sending them to the freezer at −24° C. to freeze for 8 hours; taking the blueberries out of the freezer and sending them directly to the crusher for crushing, to obtain the mixture of blueberry juice and skin dregs, then being naturally heated to 20° C. for later use.

Step S3, Composite Juice Fermentation

Adding 100 g of the noni enzyme prepared in step S1 and 200 g of the mixture of blueberry juice and skin dregs obtained in step S2 into the fermenter, raising the temperature of the material to 30° C., and adding 10 g of Kluyveromyces marxianus and 1.5 g pectinase, and stirring them well, afterwards, keeping the fermentation at 33° C. for 24 hours.

Step S4, Filter Centrifugation

The material obtained after fermentation being filtered with a mesh screen to remove the skin dregs of blueberry, and the obtained filtrate being centrifuged at a centrifugal speed of 5000 rpm and a centrifugal time of 50 minutes; after centrifugation, the supernatant being taken and filtered through a membrane filter or a diatomaceous earth filter at a filtration temperature of 60° C. and a pressure of 3 MPa, to obtain a clear mixed juice, then degassed and filled.

If the juice should be diluted, and be added with sugar or other corrigent to season, it is the supernatant after centrifugation to be added with the said sugar and the said other materials, and then filtering it through a filter.

In this step, the juice is clarified by the membrane filter, which not only has the clarification effect, but also removes the bacteria, which has the effect of sterilizing and ensuring the termination of fermentation.

### Embodiment 4

The difference between this embodiment and the embodiment 1 is that: in the step S1, the yeast is added in condition that the ambient temperature of the shade is 8° C. for fermentation.

### Embodiment 5

The difference between this embodiment and the embodiment 1 is that: in the step S1 of noni fruit pre-fermentation, the yeast s Pichia pastoris.

### Embodiment 6

The difference between this embodiment and the embodiment 1 is that: in the step S2 of blueberry pretreatment, the mixture of blueberry juice and skin dregs being obtained, and the temperature being naturally raised to 12° C. for later use.

### Embodiment 7

The difference between this embodiment and the embodiment 1 is that: in the step S3, the mass ratio of noni fruit enzyme to the mixture of blueberry juice and skin dregs being 1:2.2.

### Embodiment 8

The difference between this embodiment and the embodiment 1 is that: in the Step S3 of the composite juice fermentation, 8 g of yeast and 2 g of pectinase being added into the fermenter.

### Embodiment 9

The difference between this embodiment and the embodiment 1 is that: in the Step S4 of filtration centrifugation, the centrifugation speed being 2000 rpm, and the centrifugation time being 60 min.

### Embodiment 10

The difference between this embodiment and the embodiment 1 is that: in the Step S4 of filtration centrifugation, the filtration temperature being 30° C., and the pressure being 0.3 MPa.

### Comparative Example 1

The difference between this comparative example and the embodiment 1 is that: in the step S1 of noni fruit pre-fermentation, the weight ratio of white sugar: noni fruit: water being 0.2:1:8.

### Comparative Example 2

The difference between this comparative example and the embodiment 1 is that: in the step 51 of noni fruit pre-fermentation, the noni fruit fermentation time being 2 months.

### Comparative Example 3

The difference between this comparative example and the embodiment 1 is that: in the step S2 of blueberry pretreatment, the freezing temperature being −10° C.

### Comparative Example 4

The difference between this comparative example and the embodiment 1 is that: in the step S2 of blueberry pretreatment, the blueberries being not frozen.

### Comparative Example 5

The difference between this comparative example and the embodiment 1 is that: in the step S3 of the fermentation of composite juice, the noni enzyme of the step S1 and the blueberry juice of the step S2 being added into the fermenter, and the skin dregs of blueberry being replaced with the same amount of blueberry juice.

### Comparative Example 6

The difference between this comparative example and the embodiment 1 is that: in the step S3 of composite juice fermentation, the fermentation temperature being 35° C.

1. Determination of Anthocyanin Content

Determination method: extracting with methanol solution, using ultraviolet spectrophotometer, measuring the anthocyanin content at a wavelength of 550 nm

| | anthocyanin content (mg/100 g) |
|---|---|
| embodiment 1 | 65.0 |
| embodiment 2 | 55.2 |
| embodiment 3 | 55.8 |
| embodiment 4 | 50.3 |
| embodiment 5 | 52.1 |
| embodiment 6 | 52.6 |
| embodiment 7 | 42.2 |
| embodiment 8 | 46.0 |
| embodiment 9 | 52.3 |
| embodiment 10 | 55.6 |
| Comparative example 1 | 40.1 |
| Comparative example 2 | 42.3 |
| Comparative example 3 | 41.6 |
| Comparative example 4 | 40.2 |
| Comparative example 5 | 39.4 |
| Comparative example 6 | 41.3 |

It can be seen from the above table that the composite juice prepared by the present invention has a higher anthocyanin content. Comparing the embodiment 1 to 10 and the comparative example 1, the ratio of noni fruit to white sugar and water added during pre-fermentation has a certain influence on the fermentation effect of noni fruit, which makes it difficult for the anthocyanins to be fully immersed in the enzyme; compared with comparative example 2, the length of the fermentation time of noni fruit will also have an impact on the fermentation result; compared with comparative examples 3 and 4, it is by means of freezing the blueberries and at a reasonable temperature that can destroy the structure of the pulp, so that the anthocyanins can be immersed in the juice as much as possible; the comparison of comparative example 5 shows that the skin dregs of blueberry also contains anthocyanins and the skin dregs can promote the fermentation of the juice; the comparison of the comparative example 6 shows that fruit juice needs to be fermented at a reasonable temperature, and high-temperature fermentation has a certain impact on anthocyanins; the comparison of the embodiments 1 to 3 and the embodiment 4 shows that it is the fermentation with yeast at a suitable fermentation temperature that can promote the extraction of anthocyanins; the comparison of the embodiments 1 to 3 and the embodiment 5 shows that the use of Kluyveromyces marxianus is more conducive to fermentation; the comparison of the embodiments 1 to 3 and the embodiment 6 shows that it is after heating to a certain temperature that leads the fermentation more perfect; the comparison of the embodiments 1 to 3 and the embodiment 8 shows that it is the difference of the ratio of the added yeast and the pectinase that leads the difference of the fermentation effect, thereby the content of anthocyanin is also affected.

2. Stability Determination

Cold resistance: Put the composite juice in a low temperature refrigerator with a temperature of −10±1° C., take it out after 24 hours, and leave it at room temperature for a certain period of time to observe whether there is stratification. Parallel repeated 3 times.

Heat resistance: Place the composite juice in a constant temperature box at a temperature of 40+1° C., take it out after 24 hours, and return to room temperature to observe whether there is stratification. Parallel repeated 3 times.

Centrifugation test: Take 40 mL composite juice, set the centrifugal speed to 2000, 3000, 4000 r/min respectively, centrifuge for 30 min, and observe whether there is stratification. Parallel repeated 3 times.

The measurement results are as follows:

| | Stability determination | | |
|---|---|---|---|
| | Cold resistance | Heat resistance | Centrifugation test |
| embodiment 1 | − | − | − |
| embodiment 2 | − | − | − |
| embodiment 3 | − | − | − |
| embodiment 4 | − | − | − |
| embodiment 5 | − | − | − |
| embodiment 6 | − | − | + |
| embodiment 7 | + | − | + |
| embodiment 8 | − | − | − |
| embodiment 9 | − | − | + |
| embodiment 10 | + | − | + |
| Comparative | ++ | + | ++ |
| example 1 | | | |
| Comparative | + | + | ++ |
| example 2 | | | |
| Comparative | + | + | + |
| example 3 | | | |
| Comparative | ++ | ++ | + |
| example 4 | | | |
| Comparative | + | +++ | ++ |
| example 5 | | | |
| Comparative | + | + | +++ |
| example 6 | | | |

Clarification and no stratification: −
Precipitation stratification: +
Pigment stratification: ++
Precipitation and pigment stratification: +++

3. Sensory Evaluation

160 people were randomly selected and divided into 16 groups. Each group consisted of 10 people to form a sensory evaluation team. Before other indicators were measured, the four indicators of form, aroma, taste, and color were first evaluated. The evaluation standards are shown in the table.

| Item | Evaluation standards | score |
|---|---|---|
| Form | Clear and transparent, no precipitation, uniform, no | 20-30 |
| (30 score) | suspended matter | |
| | Slightly opaque, with a small amount of precipitation | 10-19 |
| | Turbidity, with obvious precipitation | 0-9 |
| Aroma | Rich blueberry aroma, not pungent | 20-30 |
| (30 score) | Light fragrance, slightly pungent | 10-19 |
| | Sour, pungent | 0-9 |
| Taste | Soft taste, moderate sweet and sour | 16-20 |
| (20 score) | The taste being slightly rough, with too much sourness | 10-15 |
| | or sweetness | |
| | Strong alcohol and astringency, strong bitterness | 0-9 |
| Color | Purple luster, translucent | 16-20 |
| (20 score) | Light purple luster, slightly translucent | 10-15 |
| | lilac colour, lackluster, opaque | 0-9 |

The quality test results of the composite juice of embodiment 1 to 10 and comparative examples 1 to 6 are as follows:

| Group | Form | Aroma | Taste | Color | Total Score |
|---|---|---|---|---|---|
| embodiment 1 | 30 | 30 | 19 | 19 | 98 |
| embodiment 2 | 29 | 27 | 18 | 19 | 92 |
| embodiment 3 | 29 | 28 | 19 | 19 | 95 |
| embodiment 4 | 28 | 26 | 19 | 17 | 90 |
| embodiment 5 | 28 | 25 | 18 | 18 | 89 |
| embodiment 6 | 24 | 23 | 16 | 18 | 81 |
| embodiment 7 | 25 | 20 | 15 | 17 | 77 |
| embodiment 8 | 22 | 25 | 15 | 16 | 78 |
| embodiment 9 | 23 | 22 | 18 | 17 | 80 |
| embodiment 10 | 22 | 23 | 16 | 16 | 77 |
| Comparative | 19 | 23 | 16 | 16 | 74 |
| example 1 | | | | | |
| Comparative | 24 | 19 | 15 | 15 | 73 |
| example 2 | | | | | |
| Comparative | 22 | 25 | 15 | 16 | 78 |
| example 3 | | | | | |
| Comparative | 25 | 23 | 14 | 17 | 79 |
| example 4 | | | | | |
| Comparative | 25 | 24 | 16 | 14 | 79 |
| example 5 | | | | | |
| Comparative | 25 | 23 | 17 | 15 | 80 |
| example 6 | | | | | |

From the above table, it is known that the composite juice of the present invention is fermented by a specific process, and the juice has a clear and transparent form, no precipitation, uniformity, no suspended matter, strong blueberry aroma, non-pungent, soft taste, moderate sweetness and sourness, purple luster, and transparency.

The above descriptions are only the preferred embodiments of the present invention and are not intended to limit the present invention. Any modification, equivalent replacement, improvement, etc. made within the spirit and principle of the present invention shall be included in the scope of protection of the present invention.

We claim:

1. A preparation method of a composite juice mixed by noni fruit and blueberry, wherein it comprises the following steps:
noni fruit pre-fermentation: brushing a skin of a mature noni fruit; cutting it into slices with a thickness of 1˜5 mm; according to a weight ratio, white sugar:noni fruit:water=(0.8˜1.2):(1˜3):(10˜30), putting them into a fermentation container; then adding yeast and leaving the container in a cool place to ferment for 3˜6 months; shaking the fermentation container every day for the first month; after the fermentation, filtering the material, and using the filtrate thereof to obtain a noni enzyme;
blueberry pretreatment: washing and drying blueberries, then sending them to the freezer at −15˜24° C. to freeze for 4˜8 h, taking them out and crushing them to obtain a mixture of a blueberry juice and skin dregs, and the mixture will be warmed up naturally for later use;
fermentation of the composite juice: adding the noni enzyme from the noni fruit pre-fermentation and the mixture of blueberry juice and skin dregs from the blueberry pretreatment into the fermentation container, raising a temperature of the materials to 20˜30° C., adding yeast and pectinase, stirring evenly, and fermenting for 20˜24 h;
filtration and centrifugation: filtering the fermented material with a mesh screen to remove the blueberry skin dregs, centrifuging the obtained filtrate, taking a supernatant after centrifugation, filtering through a membrane filter or diatomaceous earth filter, degassing and filling, and obtaining the composite juice.

2. The preparation method according to claim 1, wherein: in the noni fruit pre-fermentation, the ambient temperature in the cool place is 10˜18° C.

3. The preparation method according to claim 1, wherein: in the noni fruit pre-fermentation, the yeast is Kluyveromyces marxianus, and the yeast with an 100˜110 fu/g inoculum amount being inoculated.

4. The preparation method according to claim 1, wherein: in the step S1 of the noni fruit pre-fermentation, the fermentation container is shaken for 2 to 4 hours every day for the first month, and a shaking frequency is 300˜500 rpm.

5. The preparation method according to claim 1, wherein: in the blueberry pretreatment, a temperature is naturally raised to 15˜20° C.

6. The preparation method according to claim 1, wherein: in the fermentation of the composite juice, a mass ratio of the noni enzyme to the mixture of blueberry juice and skin dregs is 1:0.5˜2.

7. The preparation method according to claim 1, wherein: in the fermentation of the composite juice, 8˜10 parts by weight of yeast and 0.5˜1.5 parts by weight of pectinase are added to the fermentation container.

8. The preparation method according to claim 1, wherein: in the fermentation of the composite juice, a fermentation temperature is 20˜33° C.

9. The preparation method according to claim 1, wherein: in the filtration and centrifugation, a centrifugal speed is 3000˜5000 rpm, and a centrifugal time is 30˜50 min.

10. The preparation method according to claim 1, wherein: in the filtration and centrifugation, a filtration temperature is 40˜60° C., and a pressure is 0.5˜3 MPa.
